(19) United States
(12) Patent Application Publication
(10) Pub. No.: US 2019/0015899 A1
(43) Pub. Date: Jan. 17, 2019

(54) METHOD AND MACHINE FOR MANUFACTURING GREEN PIECES MADE OF CERAMIC AND/OR METALLIC MATERIAL BY THE TECHNIQUE OF ADDITIVE MANUFACTURING

(71) Applicant: S.A.S 3DCeram-Sinto, Limoges (FR)

(72) Inventors: Christophe CHAPUT, Le Palais-Sur-Vienne (FR); Richard GAIGNON, Saint-Vrain (FR)

(21) Appl. No.: 16/034,907

(22) Filed: Jul. 13, 2018

(30) Foreign Application Priority Data
Jul. 13, 2017 (FR) 1756694

(51) Int. Cl. B22F 1/00; B22F 3/105; B22F 3/24; C04B 35/64

(52) U.S. Cl. CPC B22F 1/0062; B22F 3/1055; B22F 3/24; C04B 35/64; B33Y 10/00; B22F 2003/1057; B22F 2003/247; B22F 2003/1058; B22F 2003/1059

(57) ABSTRACT

In a method of manufacturing, before making the first layer: the working tray is covered with a support sheet able to be biased against it, forming a rigid and fixed surface for receiving the successive layers, which is able to hold thereon the successive layers as formed; and the support sheet is biased against the working tray; the green piece is formed by the technique of additive manufacturing; and when the green piece is thus formed, the biasing is suppressed in order to detach, from the tray, the support sheet on which the green piece is located with the portion of the photocurable composition which has not been cured; the non-cured photocurable composition portion is removed; and the green piece is unhooked from the support sheet.

The present invention relates to a method and machine for manufacturing green pieces by additive manufacturing, such green pieces being intended to be subjected to cleaning, debinding and sintering operations so as to obtain finished ceramic and/or metallic pieces.

The technique of additive manufacturing, also called stereolithography, generally comprises the following steps, in order to provide these green pieces:
building, by computer-aided design, a computer model of the piece to be manufactured, the sizes of the model being slightly larger than those of the piece to be manufactured so as to anticipate a shrinking of the ceramic or metallic material during the manufacturing of the piece; and
manufacturing the piece by means of the technique of additive manufacturing, consisting in:
   forming, on a rigid support, a first layer of a photocurable composition comprising at least one ceramic or metallic material, at least one photocurable monomer and/or oligomer, at least one photoinitiator and, when appropriate, at least one plasticizer and/or at least one solvent and/or at least one dispersant;
   curing the first layer of the photocurable composition by irradiation (by laser scanning of the free surface of said layer or by a diode projection system) according to a pattern defined from the model for said layer, forming a first stage;
   forming, on the first stage, a second layer of the photocurable composition;
   curing the second layer of the photocurable composition, by irradiation according to a pattern defined for said layer, forming a second stage, this irradiation being carried out in the same way as the first layer;
   optionally, the steps mentioned above are repeated until the green piece is obtained.

Then, as indicated above, in order to obtain the finished piece, the green piece is cleaned in order to remove the non-cured composition; the cleaned green piece is debinded; and the cleaned and debinded green piece is sintered in order to obtain the finished piece.

The piece can be manufactured by a pasty process or a liquid process.
In a manufacturing by a pasty process, the photocurable composition is under the form of a paste the viscosity of which can vary in particular from 1 Pa·s. to infinity with a zero shear rate, and the rigid support is a working tray supporting the different layers of the piece being built as well as the paste, and each of the layers is generally formed by lowering the working tray and spreading a predefined paste thickness. A supply of paste is stored within containers which are automatically emptied of a predefined paste amount at each layer by means of a piston. It results in the creation of a paste bead to be spread on the upper layer of the piece being built which had been lowered beforehand by the working tray. Each layer is generally spread by scraping by a scraping blade which sweeps the working surface of the working tray, for example, by advancing along a straight horizontal direction.
In a manufacturing by a liquid process, the photocurable composition is under the form of a slurry having a low viscosity.
In a first embodiment by the liquid process, the rigid support is a tray which is lowered in a bath of the photocurable slurry in order to cover it with a layer of said slurry, the layer being then cured by irradiation as indicated above. On this first layer, each of the other layers is then successively formed by lowering step by step the tray in the bath such that the upper stage of the piece being built is lowered under the free surface of the photocurable slurry in order to form the layer in question, which is then irradiated.
In a second embodiment by the liquid process, the photocurable slurry is contained within a container with a bottom transparent for irradiation, and the piece is held on a rigid support which is a tray being raised step by step. Thus, a bottom layer is first cured, then the tray is raised by a step to allow the slurry to constitute a new layer which is then cured, the operation being repeated for each layer.
In a third embodiment of the liquid process, the photocurable slurry is spread into a layer on a film transparent for irradiation, the film being able to be horizontally unrolled. The piece is formed on a rigid tray which is lowered to contact the layer which is cured by irradiation through the film. A new film segment coated with a new photocurable layer is then unrolled and the operation is reiterated until the piece is completely finished.

It is important to provide a good binding between the working surface, that is, the rigid working tray (upper face of the working tray in the case of the pasty process and the above-mentioned first embodiment of the liquid process, respectively, and lower face of the tray in the case of the above-mentioned second and third embodiments of the liquid process), and the piece which is built by stacking the layers.

In order to promote the manufacture of the piece, it is necessary that the restraining of the piece which is built on the rigid tray be as rigid as possible. In case of a poor restraining, the piece is likely to move during its manufacturing. Such a risk is particularly important when a scraping system is used to stack the layers (pasty process), all the more so as the pastes being used have a high viscosity and the layers being spread have a low thickness. These combined parameters lead to put high stresses during the passage of the scraper. Thus, a piece which moves during its manufacturing will be poorly built or will not observe the desired geometric tolerances.

Furthermore, once the piece is built, it is necessary to be able to remove it from the rigid tray without damaging it. During this removal step, it is necessary to apply a stress on the piece in order to detach it. Thus, the operator will use a tool such as a spatula which is likely to damage the piece as it will deform the piece in order to twist it so in order to unhook it.

In order to solve this restraining problem in order to improve the quality of the pieces and the reliability of their manufacturing by the additive manufacturing, the Applicant searched for a solution providing a high restraining force which has to be held during all the stacking of the layers, and allowing to remove the piece without damaging it, and without carrying out complex operations for mounting or preparing the rigid support. It can be noted that the restraining force should be such that any movement of the piece during its manufacturing should be prevented, such a movement resulting in the impossibility of observing the tolerances, a green piece surface condition being of poor quality due to a wrong overlap of the layers, and a breaking of the pieces after a direct contact with the scraper.

According to the invention, a support sheet will be arranged on the rigid tray and will be restrained, that is, carefully attached, by biasing on the rigid tray, said support sheet being made of a material able, once the green piece is finished, to be deformed by a stress, in order to allow it to be detached, the biasing being suppressed.

The present invention first relates to a method for manufacturing, by the technique of additive manufacturing, a green piece made of at least one material selected from the ceramic materials and the metallic materials, method according to which layers of a photocurable composition comprising said ceramic and metallic material(s) in a powdered state and an organic part comprising at least one photocurable monomer and/or oligomer and at least one photoinitiator are successively allowed to cure by irradiation according to a pattern defined for each layer, the first layer being formed on a working tray, and each other layer being formed and then cured on the preceding layer, characterized by the fact that:
before making the first layer:
   the working tray is covered with a support sheet able to be biased against it, forming a rigid and fixed surface for receiving the successive layers, which is able to hold thereon the successive layers as formed; and
   said support sheet is biased against said working tray;
the green piece is formed by the technique of additive manufacturing; and
when the green piece is thus formed, the biasing is suppressed in order to detach, from said tray, said support sheet on which the green piece is located with the portion of said photocurable composition which has not been cured;
said non-cured photocurable composition portion is removed; and
said green piece is unhooked from said support sheet.

The ceramic materials are the powdered sinterable ceramic materials selected in particular from alumina (Al₂O₃), zirconia (Zr₂), alumina-reinforced zirconia, zircon (ZrSiO₄), silica (SiO₂), hydroxyapatite, silica zircon (ZrSiO₄+SiO₂), silicon nitride, tricalcium phosphate (TCP), aluminum nitride, silicon carbide, cordierite and mullite.

The metallic materials are the powdered sinterable metal materials selected from the pure metals, such as Al, Cu, Mg, Si, Ti, Zn, Sn, Ni, . . . , the alloys thereof and the mixtures of pure metals and the alloys thereof.

Preferably, a deformable support sheet is selected to allow, when the biasing is suppressed, to unhook the green piece from its support sheet by applying a stress on said support sheet so as to deform the latter for releasing the green piece.

According to particular embodiments of the method according to the present invention, a pasty photocurable composition can be used and is spread layer after layer on the working tray, the layers being irradiated from above, or a slurry photocurable composition can be used,

the tray being lowered step by step in the slurry in order to form the successive layers irradiated from above, or
the tray being disposed at a distance corresponding to the thickness of a layer from the bottom of a photocurable composition container with a bottom transparent for irradiation and raised at each layer formation, the layers being every time irradiated from below; or
the tray coming into contact, at each layer formation, with a slurry layer applied on a segment of a transparent film which is horizontally unrolled in order to provide a new segment at each layer formation, the layers being irradiated every time from below.

According to a first particular embodiment of the method according to the present invention, the biasing is carried out by sucking said support sheet against said working tray.

According to a first variant of this first embodiment, a perforated or porous planar plate made of a rigid material, such as a ceramic, metallic or plastic material, is used as a working tray, the free face of which is covered with the support sheet and which is connected, by the opposite face thereof, to a vacuum pump or a vacuum generator, which is activated to press the support sheet on the free face of the tray, forming the rigid and fixed surface for receiving the successive layers of photocurable composition, and is deactivated to detach said support sheet from said tray.

Particularly, a perforated plate is used, the perforations of which are in particular under the form of holes and/or slots connected to the vacuum pump or to the vacuum generator, and arranged to ensure, when said pump or generator is operated, that the support sheet is pressed.

The holes and/or slots have any shape and can advantageously be sized and/or arranged to ensure that the support sheet is correctly pressed, by increasing the depression at some places, if desired. Examples are holes with a diameter of 0.01-5 mm, spaced by 0.1-50 mm, or slots with a width of 0.01-5 mm, spaced by 0.1-50 mm. The holes are not necessarily circular and are not necessarily arranged as a grid pattern and the slots do not necessarily have a constant width on the entire height thereof.

According to a second variant of this first embodiment, a flat receptacle, in particular made of metal or plastic material, is used as a working tray, the bottom of which has perforations connected to a vacuum pump and which receives a grid, in particular made of metal, the support sheet being applied on the free edge of the receptacle and on the grid, said vacuum pump being activated in order to press said support sheet on the free edge of the receptacle and on the grid, forming the rigid and fixed surface for receiving the successive layers of photocurable composition, and being deactivated in order to detach said support sheet from said tray.

In this first embodiment of the present invention:
a support sheet with a thickness of 0.05-5 mm can be used; in any case, a thickness of a sheet should not prevent the deformation thereof;
a support sheet made of polyvinyl chloride or polyvinyl alcohol can be used;
a vacuum of 13.33 Pa-10⁻¹⁰ Pa (0.133 mbar-10¹² mbar) can be generated.

According to a second particular embodiment of the method according to the present invention, the biasing is carried out by magnetic attraction of said support sheet, which is made of a ferromagnetic material, on the working tray, which is able to generate a controllable magnetic flux, said magnetic flux being activated in order to press said support sheet on said tray and being deactivated in order to detach said support sheet from said tray.

According to a first variant of this second embodiment, a magnetic tray with permanent magnets, which can be mechanically activated or deactivated, is used as a tray.

According to a second variant of this second embodiment, an electromagnetic tray with coil(s) is used as a tray, the magnetic flux being activated when a direct current is sent to the coil(s) and deactivated when no current flows through the coil(s).

The present invention also relates to a machine for the manufacturing, by the technique of additive manufacturing, of green pieces made of a material selected from the ceramic materials and the metallic materials, according to which layers of a photocurable composition comprising said ceramic and metal material(s) in a powdered state and an organic part comprising at least one photocurable monomer and/or oligomer and at least one photoinitiator are allowed successively to cure by irradiation according to a pattern defined for each layer, the first layer being formed on a working tray, and each other layer being formed and then cured on the preceding layer,

said machine also comprising means for irradiating the successive layers,

characterized by the fact that the machine comprises means for biasing, against said working tray, a support sheet intended to cover it before the formation of the first layer, forming a rigid and fixed surface for receiving the successive layers, able to hold thereon the successive layers as formed, said biasing means being able to be deactivated in order to detach, from said tray, said support sheet on which the green piece is located with the portion of the photocurable composition which has not been cured.

Preferably, the support sheet can be selected to be deformable in order to allow, when the biasing is suppressed, the green piece to be unhooked from its support sheet by applying a stress on said support sheet so as to deform it in order to release the green piece. A sheet with a thickness of 0.05-1 mm can be used. In any case, a thickness of a sheet which does not prevent the deformation thereof is selected.

The machine according to the present invention can have the following particular features:
it is intended to form green pieces from a pasty photocurable composition and it comprises means for scraping the paste in order to spread the successive layers on the working tray, above which the support sheet is located, the irradiation means being arranged above it; or
it is intended to form green pieces from a slurry photocurable composition; and
   it comprises a vat to be filled with said slurry, in which the working tray, on which the support sheet is located, is able to be lowered step by step to form thereon, at each step, a layer to be irradiated, the irradiation means being arranged above said tray; or
   it comprises a container with a bottom transparent for irradiation, in which the tray, under which the support sheet is located, is able to raise step by step to form, at each step, between the bottom and said support sheet, a layer to be irradiated, the irradiation means being arranged below said bottom of said tank; or
   it comprises a device allowing to horizontally unroll a sheet transparent for irradiation forming successive sheet segments receiving every time a photocurable composition layer, the working tray, under which the support sheet is located, being able to be lowered on the layer to be irradiated arranged every time on a segment of transparent sheet, the irradiation means being arranged below said transparent sheet.

According to a first particular embodiment of the machine according to the present invention, the biasing means are means for restraining by suction, in particular constituted by a vacuum pump, such as a vane pump, a diaphragm pump, a piston pump, or a vacuum generator such as a Venturi effect generator, said sucking means being in particular able to generate a vacuum of 13.33 Pa-10⁻¹⁰ Pa (0.133 mbar-10⁻¹² mbar).

According to a first variant of this first embodiment of the machine according to the invention, the working tray is a perforated or porous planar plate made of a rigid material, such as a ceramic, metallic or plastic material, the free face of which is covered with the support sheet and which is connected, by the opposite face thereof, to a vacuum pump or a vacuum generator, which is activated to press the support sheet on the free face of the tray forming the rigid and fixed surface for receiving the successive layers of photocurable composition, and deactivated in order to detach said support sheet from said tray.

Particularly, the working tray can be a perforated plate, the perforations of which are in particular under the form of holes and/or slots connected to the vacuum pump or the vacuum generator, arranged to ensure, when it is operated, that the support sheet is pressed.

According to a second variant of this first embodiment of the machine according to the invention, the working tray is a flat receptacle, in particular made of metallic or plastic material, the bottom of which has perforations connected to a vacuum pump and which receives a grid, in particular made of metal, the support sheet applying on the free edge of the receptacle and on the grid, said vacuum pump being activated in order to press said support sheet on the free edge of the receptacle and on the grid, forming the rigid and fixed surface for receiving the successive layers of photocurable composition, and being deactivated in order to detach said support sheet from said tray.

In this first embodiment of the machine according to the present invention:
the support sheet can have a thickness of 0.05-5 mm; in any case, a thickness of a sheet should not prevent the deformation thereof;
the support sheet can be a sheet made of polyvinyl chloride or polyvinyl alcohol (the latter being water soluble).

According to a second embodiment of the machine according to the present invention, the biasing means are means ensuring a magnetic attraction of said support sheet, which is made of a ferromagnetic material, on the working tray, which is able to generate a controllable magnetic flux, said magnetic flux being activated in order to press said support sheet on said tray and deactivated in order to detach said support sheet from said tray.

In a first variant of this second embodiment, the working tray is a magnetic tray with permanent magnets, which can be mechanically activated or deactivated.

In a second variant of this second embodiment, the working tray is an electromagnetic tray with coil(s), the magnetic flux being activated when a direct current is sent to the coil(s) and being deactivated when no current flows through the coil(s).

In order to better illustrate the object of the present invention, particular embodiments will be described below, for indicative and non-limiting purposes, in reference to the appended drawings.

In the drawings:

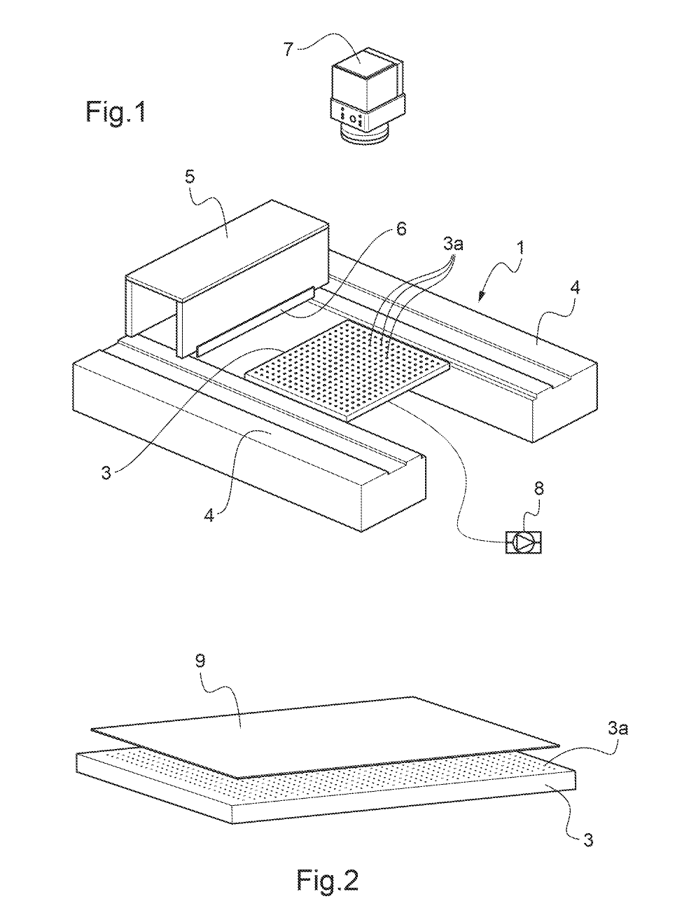

FIG. 1 is a perspective schematic view of a machine according to the invention for manufacturing, by a pasty process, a green piece made of ceramic material, comprising a working tray carried out according to a first embodiment, the support sheet being omitted from this figure;

FIG. 2 is, on a larger scale, an exploded perspective view of the working tray and the support sheet equipping the machine of FIG. 1;

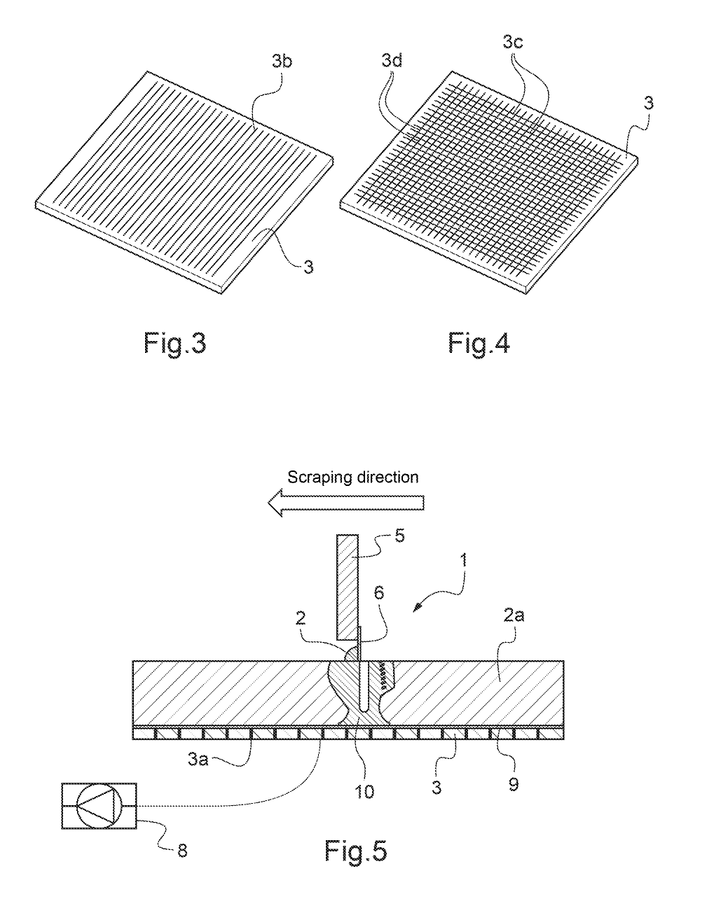

FIGS. 3 and 4 are perspective views of a working tray carried out according to variants of that of FIGS. 1 and 2;

FIG. 5 is, on a larger scale, a cross-sectional schematic view of a piece being manufactured on the working tray of the machine of FIG. 1, said cross section being made along the scraping direction;

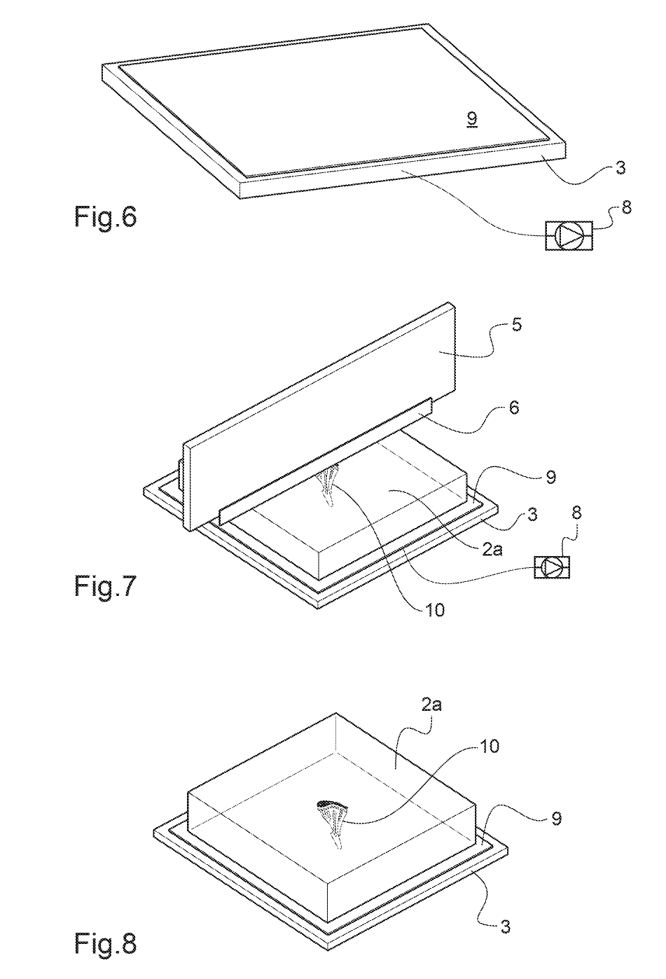

FIGS. 6-11 illustrate the building of a piece with the machine of FIG. 1;

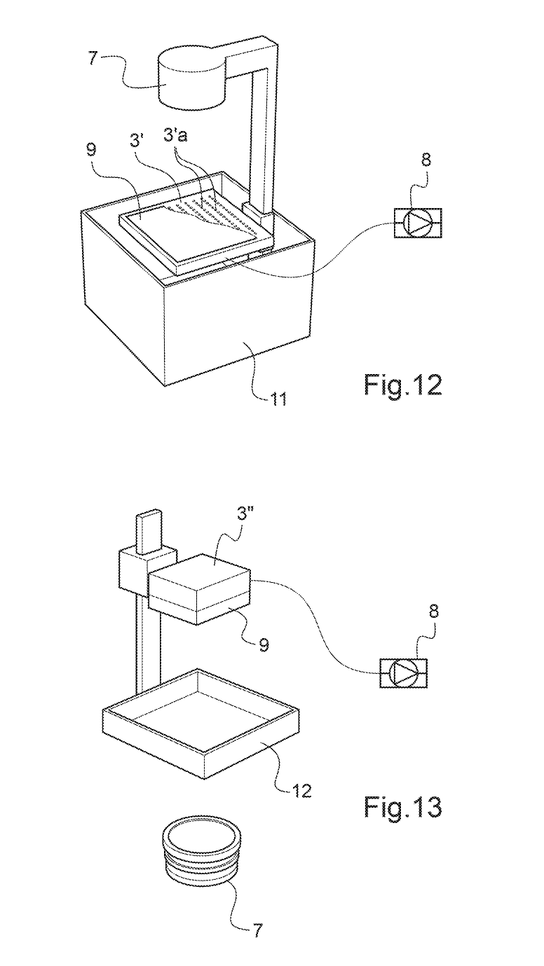

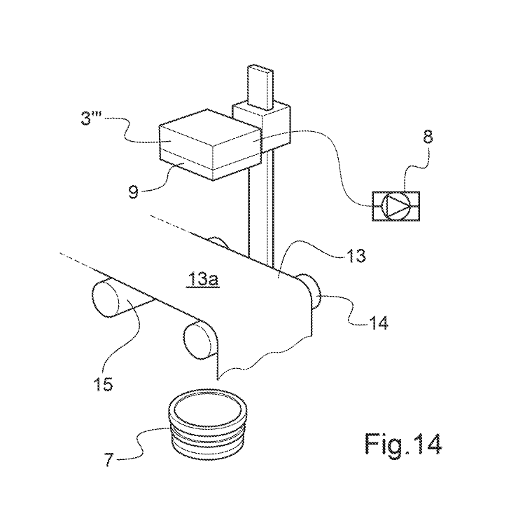

FIGS. 12-14 are schematic views similar to FIG. 1 of a machine for manufacturing, by a liquid process, a green piece made of ceramic material by the technique of additive manufacturing, with means for irradiating from above for the machine of FIG. 12 and from below for the machines of FIGS. 13 and 14, respectively;

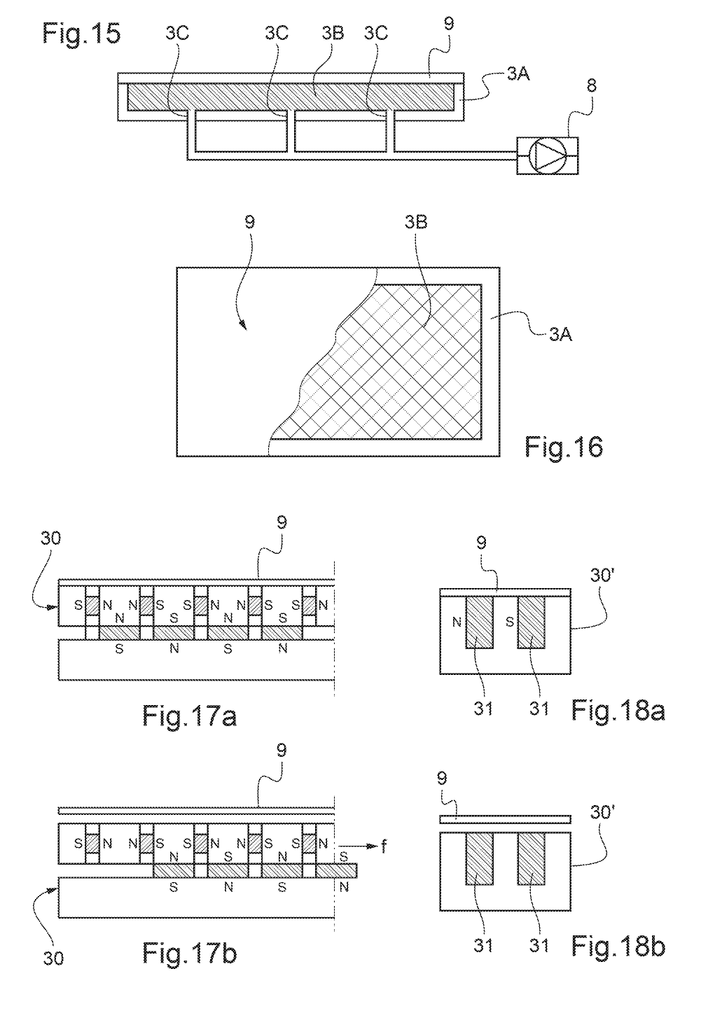

FIG. 15 is a cross-sectional schematic view of a working tray covered with the support sheet, the working tray being made according to a variant of the preceding figures;

FIG. 16 is a top view of the tray of FIG. 15 with the support sheet, the latter being shown with a partial pulling out;

FIGS. 17a and 17b are cross-sectional schematic views of a working tray made according to a first variant of a second embodiment of the present invention, in the respective positions for applying and detaching the support sheet in relation to said tray; and

FIGS. 18a and 18b are views corresponding to FIGS. 17a and 17b, respectively, of a second variant of this second embodiment.

When referring to FIG. 1, it can be noted that a device 1 for scraping a paste layer 2 on a working surface of a working tray 3 of a machine for manufacturing green bodies made of ceramic material by the technique of additive manufacturing is shown. The scraping device 1, slidably mounted on the frame 4 of the machine, comprises a gantry 5 carrying, at the front, a scraping blade 6 having a horizontal scraping edge.

The working tray 3 has a matrix of evenly distributed through holes 3a. According to variants shown in FIGS. 3 and 4, the holes 3a are replaced with slots 3b parallel to an edge of the working tray (FIG. 3), or slots 3c arranged to form a grid pattern (FIG. 4).

In FIG. 1, the galvanometric head 7 is also shown, which directs the laser beam as well as a suction system 8 the function of which will be described below.

In FIG. 5, the support sheet 9 is shown, the function of which is indicated below, as well as the objet 10 being manufactured.

The operation of the machine of FIG. 1 will now be described with reference to FIGS. 6-11.

### FIG. 6

At the beginning of the manufacturing, the working tray 3 is put under depression by activating the suction system 8 in order to suck and restrain the sheet 9 which will act as a building support.

### FIG. 7

The suction is maintained for the entire duration of printing in order to provide a fixed and rigid base to the printed piece 10.

### FIG. 8

After printing, the vacuum is broken.

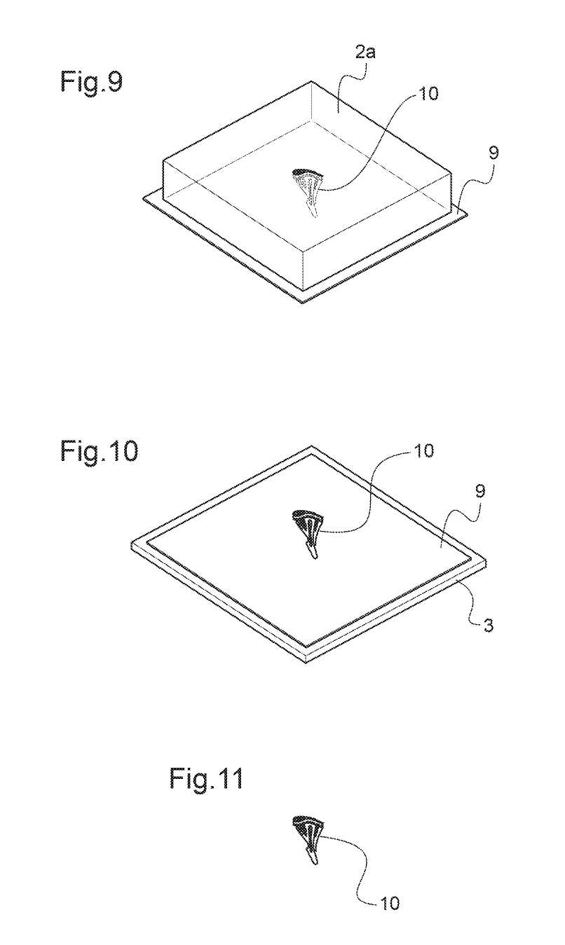

### FIG. 9

The sheet 9 supporting the piece 10 is easily separated from the working tray 3.

### FIG. 10

The non-cured paste 2a around the piece 10 is removed. The piece 10 is still on the support sheet 9.

### FIG. 11

The sheet 9 is deformed in order to unhook the piece 10 without damaging it.

### EXAMPLE

A green piece made of ceramic material has been manufactured using the machine of FIG. 1.

A working tray 3, drilled with a matrix of holes 3a with a diameter of 1 mm and spaced from each other by 7 mm, has been used. A sheet 9 made of polyvinyl chloride with a thickness of 100 μm has been placed on this working tray 3 in order to be sucked; a vacuum of 1 mbar (100 Pa) was generated to that end using a vane pump 8.

Once the green piece 10 is finished, the vacuum is released. The piece 10 is cleaned in order to remove the non-cured paste 2a. The piece 10 is then easily detached from the support sheet 9.

When referring to FIGS. 12-14, a machine for manufacturing green ceramic pieces by a liquid process has been schematically shown, with irradiation from above, from below and from below, respectively.

The machine of FIG. 12 comprises a vat 11 in which the photocurable suspension is placed. A perforated horizontal tray 3′ drilled with holes 3′a is mounted in order to be lowered step by step in the vat 11 so as to be covered every time by a photocurable slurry layer, which will be irradiated by the irradiation means 7. According to the invention, a support sheet 9 is placed on the tray 3′ and sucked against the latter by the suction system 8, as previously described with reference to FIG. 1.

The machine of FIG. 13 comprises a container 12 with a bottom transparent for irradiation. This container will be filled with the photocurable slurry. A horizontal platform 3″ drilled with holes 3″ a is mounted to be able to be located in the container 12 parallel to the bottom thereof and at a distance therefrom corresponding to the thickness of the first layer to be formed on said tray 3″ which constitutes the rigid building support of the piece, the irradiation being performed by the means 7 located below said bottom. According to the invention, a support sheet 9 is pressed by suction by the suction system 8 below said tray 3″, which, after the formation of the first layer, is raised step by step in the container 12 for forming each of the other layers.

The machine of FIG. 14 comprises a film 13 which is transparent to irradiation, unrolls from a reel 14 and rolls on a reel 15. Whenever a layer should be formed, the segment 13a of the film 13 between the reels 14 and 15 is covered with a photocurable slurry layer, and the tray 3′″/support sheet 9 assembly—of the same type as the tray 3″/support sheet 9 assembly of FIG. 13—is lowered to contact the slurry layer as applied, which is cured by irradiation from below through the transparent film. The tray 3′″/support sheet 9 assembly is then raised to allow a new slurry layer to be applied on the next segment of the film which has been unrolled. The operation is repeated until providing the desired green piece.

When referring to FIGS. 15 and 16, a working tray made according to a variant is shown. This tray is constituted by a receptacle 3A, with a flat bottom, for example made of metal, in which is placed a grid 3B, for example made of metal, being assigned with the peripheral free edge of the receptacle 3A. The bottom of the receptacle 3A has holes 3C connected to the vacuum pump 8. The grid 3B allows to distribute the depression and the receptacle 3A constitutes a frame ensuring the stiffness when the support sheet 9 is applied on the peripheral edge thereof and on the grid 3B.

It would be possible for the grid 3B to be located slightly above the edge of the receptacle 3A, but it is not possible for the grid 3B to protrude from said edge of the receptacle 3A.

When referring to FIGS. 17a and 17b, a tray 30, which is constituted by a magnetic platform with permanent magnets which can be mechanically activated (FIG. 17a) and deactivated (FIG. 17b) by translation along the arrow f, is schematically shown in section. During the activation, the support sheet, here made of a ferromagnetic material, is securely applied on the upper face of the tray 30 and, during the deactivation, the support sheet 9 is detached from the tray 30. This technology is implemented by Braillon company (http://www.braillon.com/français/nostechnologies.html).

When referring to FIGS. 18a and 18b, a platform 30′ with coils 31, on which the support sheet 9 is applied, is schematically shown in section. This technology is also implemented by the Braillon company.

A magnetic field is generated by exciting the coils 31 with a direct current, the support sheet 9 being held (FIG. 18a). When no current passes through the coils 31, the support sheet 9 is detached.

1-25. (canceled)

26. A method for manufacturing, by the technique of additive manufacturing, a green piece made of at least one material selected from the ceramic materials and the metallic materials, method according to which layers of a photocurable composition comprising the at least one material in a powdered state and an organic part comprising at least one among a photocurable monomer and a photocurable oligomer and at least one photoinitiator are successively allowed to cure by irradiation according to a pattern defined for each layer, the first layer being formed on a working tray, and each other layer being formed and then cured on the preceding layer, wherein:
before making the first layer:
the working tray is covered with a support sheet able to be biased against the working tray, forming a rigid and fixed surface for receiving the successive layers, the rigid and fixed surface being able to hold thereon the successive layers as formed; and
the support sheet (is biased against the working tray;
the green piece is formed by the technique of additive manufacturing; and
when the green piece is formed, the biasing is suppressed in order to detach, from the tray, the support sheet on which the green piece is located with the portion of the photocurable composition which has not been cured (2a);
the non-cured photocurable composition portion is removed; and
the green piece is unhooked from the support sheet.

27. The method according to claim 26, wherein a deformable support sheet is selected to allow, when the biasing is suppressed, to unhook the green piece from its support sheet by applying a stress on the support sheet so as to deform the support sheet for releasing the green piece.

28. The method according to claim 26, wherein the biasing is carried out by sucking the support sheet against the working tray.

29. The method according to claim 28, wherein a planar plate selected from a perforated planar plate and a porous planar plate made of a rigid material, is used as a working tray, the free face of the working tray being covered with the support sheet, and the face of the working tray opposite the free face is connected to a vacuum machine selected from vacuum pumps and vacuum generators, the vacuum machine being activated to press the support sheet on the free face of the tray, forming the rigid and fixed surface for receiving the successive layers of photocurable composition, and is deactivated to detach the support sheet from the tray.

30. The method according to claim 29, wherein a perforated plate is used, the perforations of the perforated plate are selected from holes and slots connected to the vacuum machine, and arranged to ensure, when the vacuum machine is operated, that the support sheet is pressed.

31. The method according to claim 28, wherein a flat receptacle is used as a working tray, the bottom of the flat receptacle having perforations connected to a vacuum pump and receiving a grid, the support sheet being applied on the free edge of the receptacle and on the grid, the vacuum pump being activated in order to press the support sheet on the free edge of the receptacle and on the grid, forming the rigid and fixed surface for receiving the successive layers of photocurable composition, and being deactivated in order to detach the support sheet from the tray.

32. The method according to claim 28, wherein a vacuum of 13.33 Pa-10⁻¹⁰ Pa (0.133 mbar-10⁻¹² mbar) is generated.

33. The method according to claim 26, wherein the biasing is carried out by magnetic attraction of the support sheet, being made of a ferromagnetic material, on the working tray, is the working tray being able to generate a controllable magnetic flux, the magnetic flux being activated in order to press the support sheet on the tray and being deactivated in order to detach the support sheet from the tray and wherein a magnetic tray with mechanically activated and deactivated permanent magnets is used as a tray.

34. The method according to claim 26, wherein the biasing is carried out by magnetic attraction of the support sheet, the support sheet being made of a ferromagnetic material, on the working tray, the working tray being able to generate a controllable magnetic flux, the magnetic flux being activated in order to press the support sheet on the tray and being deactivated in order to detach the support sheet from the tray and wherein an electromagnetic tray with at least one coil is used as a tray, the magnetic flux being activated when a direct current is sent to the at least one coil and deactivated when no current flows through the at least one coil.

35. A machine for the manufacturing, by the technique of additive manufacturing, of green pieces made of at least one material selected from the ceramic materials and the metallic materials, according to which layers of a photocurable composition comprising the at least one material in a powdered state and an organic part comprising at least one among a photocurable monomer and a photocurable oligomer and at least one photoinitiator are allowed successively to cure by irradiation according to a pattern defined for each layer, the first layer being formed on a working tray, and each other layer being formed and then cured on the preceding layer,
the machine also comprising means for irradiating the successive layers,
wherein the machine comprises means for biasing,
against the working tray, a support sheet intended to cover the working tray before the formation of the first layer, forming a rigid and fixed surface for receiving the successive layers, the rigid and fixed surface being able to hold the successive layers as formed, the biasing means being able to be deactivated in order to detach, from the tray, the support sheet on which the green piece is located with the portion of the photocurable composition which has not been cured.

36. The machine according to claim 35, wherein the support sheet is selected to be deformable in order to allow, when the biasing is suppressed, the green piece to be unhooked from its support sheet by applying a stress on the support sheet so as to deform the support sheet in order to release the green piece.

37. The machine according to claim 35, wherein the biasing means are means for restraining by suction, constituted by a vacuum machine selected from vacuum pumps selected from a vane pump, a diaphragm pump, a piston pump, and vacuum generators such as a Venturi effect generator, the sucking means being in particular able to generate a vacuum of 13.33 Pa-10⁻¹⁰ Pa (0.133 mbar-10⁻¹² mbar).

38. The machine according to claim 37, wherein the working tray is a planar plate selected from a perforated planar plate and a porous planar plate made of a rigid material, the free face of the working tray being covered with the support sheet and the face of the working tray opposite the free face being connected to a vacuum machine, the vacuum machine being activated to press the support sheet on the free face of the tray, forming the rigid and fixed surface for receiving the successive layers of photocurable composition, and deactivated in order to detach the support sheet from the tray.

39. The machine according to claim 38, wherein the working tray is a perforated plate, the perforations of the perforated plate are under the form of holes and slots connected to the vacuum machine, arranged to ensure, when the vacuum machine is operated, that the support sheet is pressed.

40. The machine according to claim 37, wherein the working tray is a flat receptacle, the bottom of the flat receptacle having perforations connected to a vacuum pump and receiving a grid, the support sheet applying on the free edge of the receptacle and on the grid, the vacuum pump being activated in order to press the support sheet on the free edge of the receptacle and on the grid, forming the rigid and fixed surface for receiving the successive layers of photocurable composition, and being deactivated in order to detach the support sheet from the tray.

41. The machine according to claim 37, wherein the support sheet has a thickness of 0.05-5 mm.

42. The machine according to claim 37, wherein the support sheet is a sheet made of a material selected from polyvinyl chloride and polyvinyl alcohol.

43. The machine according to claim 35, wherein the biasing means are means ensuring a magnetic attraction of the support sheet, the support sheet being made of a ferromagnetic material, on the working tray, the working tray being able to generate a controllable magnetic flux, the magnetic flux being activated in order to press the support sheet on the tray and deactivated in order to detach the support sheet from the tray.

44. The machine according to claim 43, wherein the working tray is a magnetic tray with mechanically activated and deactivated permanent magnets.

45. The machine according to claim 43, wherein the working tray is an electromagnetic tray with at least one coil, the magnetic flux being activated when a direct current is sent to the at least one coil and being deactivated when no current flows through the at least one coil.
